(19) United States
(12) Patent Application Publication
(10) Pub. No.: US 2013/0091527 A1
(43) Pub. Date: Apr. 11, 2013

(54) METHOD FOR SHARING TELEVISION PROGRAMS

(71) Applicants: Yung-Hung Ho, New Taipei City (TW); Min-I Chen, New Taipei City (TW)

(72) Inventors: Yung-Hung Ho, New Taipei City (TW); Min-I Chen, New Taipei City (TW)

(73) Assignee: AMTRAN TECHNOLOGY CO., LTD, New Taipei City (TW)

(21) Appl. No.: 13/423,297

(22) Filed: Mar. 19, 2012

(30) Foreign Application Priority Data
Oct. 5, 2011 (TW) 100136108

(51) Int. Cl. H04N 21/40

(52) U.S. Cl. 725/81; 725/85

(57) ABSTRACT

A method for sharing television programs is provided. The method includes following steps: pushing a first audio/video content presently being displayed at a first television device to a second television device connected to the first television device; displaying the first audio/video content at a first picture of the second television device and simultaneously displaying a second audio/video content obtained by a tuner of the second television device at a second picture of the second television device.

### CROSS-REFERENCE TO RELATED APPLICATION

This application claims the priority benefit of Taiwan application serial no. 100136108, filed Oct. 5, 2011. The entirety of the above-mentioned patent application is hereby incorporated by reference herein and made a part of this specification.

### BACKGROUND OF THE INVENTION

1. Field of the Invention

The invention generally relates to a method for sharing television programs, and more particularly, to a method for sharing television programs operated between two television devices respectively having tuners.

2. Description of Related Art

Nowadays, in a general home, the percentage of owning two television devices is gradually increased. A plurality of users in a same home may usually individually operate multiple television devices for playing different television program content or audio/video (AV) content. When a user has found a program content presently being viewed is attractive or worth to be shared with other users, the user wishes immediately sharing the television program content to the other television devices being used by other users. In another case, when a user is watching a television program content, the user may wish to simultaneously watch the program content of other TV channels, but the user is limited by that one television device mostly has one tuner, can only realize the object through sharing the television program content of other TV channels through other television devices. Therefore, how to share television program content between two or more than two television devices without additionally employing other tuners has become an important project.

### SUMMARY OF THE INVENTION

Accordingly, an exemplary embodiment of the invention is directed to a method for sharing television programs, in which television programs can be shared between two television devices respectively having a single tuner through pulling in the AV content of other channels from another television device and simultaneously displaying the local original AV content and the pulled in AV content or through pushing the AV content presently being displayed at a local television device to another television device.

According to an exemplary embodiment of the invention, the present invention provides a method for sharing television programs, which includes following steps: pushing a first audio/video content presently being displayed at a first television device to a second television device connected to the first television device; and displaying the first audio/video content at a first picture of the second television device and simultaneously displaying a second audio/video content obtained by a tuner of the second television device at a second picture of the second television device.

In an exemplary embodiment of the invention, the first picture and the second picture form a picture-in-picture (PIP), in which the first picture is a sub-picture and the second picture is a main picture, and the sub-picture is stacked on the main picture.

In an exemplary embodiment of the invention, the first picture is smaller than the second picture.

In an exemplary embodiment of the invention, prior to pushing the first AV content to the second television device, the method further includes: transmitting a notification message from the first television device to the second television device, in which the notification message includes a program name corresponding to the first AV content; and, when the first television device receives an acknowledgment message responded by the second television device, pushing the first AV content to the second television device by the first television device, in which the acknowledgment message represents that a user of the second television device agrees to watch the first AV content.

According to an exemplary embodiment of the invention, the invention provides a method for sharing television programs, which includes following steps: when a first television device presently displays a first AV content obtained by a first tuner of the first television device, controlling, through a first communication module of the first television device, a second communication module of a second television device so as to activate a second tuner of the second television device, in which a display unit of the second television device is in a deactivated state; selecting a channel by the first television device through controlling the second tuner to select a channel so as to obtain the second AV content; and obtaining the second AV content by the first television device through the second communication module.

In an exemplary embodiment of the invention, the method further includes: displaying the first AV content at a first picture of the first television device and simultaneously displaying the second AV content at a second picture of the first television device.

According to an exemplary embodiment of the invention, the invention provides a method for sharing television programs, which includes following steps: transmitting a first command by a first television device through a first communication module thereof to a second television device; receiving the first command by the second television device through a second communication module thereof and activating a tuner of the second television device according to the first command; and receiving a second command transmitted from the first television device by the second television device through the second communication module and controlling the tuner according to the second command to select a channel so as to obtain an AV content and transmitting the AV content to the first television device by the second television device through the second communication module.

In an exemplary embodiment of the invention, a display unit of the second television device is in a deactivated state.

According to an exemplary embodiment of the invention, the invention provides a method for sharing television programs suitable for a television device having one tuner only. The method includes following steps: when the television device displays a first AV content obtained by the tuner of the television device at a first picture thereof, receiving a second AV content provided by one of other television devices; and displaying the second AV content obtained through the another television device at a second picture of the television device.

According to an exemplary embodiment of the invention, the invention provides a method for sharing television programs. Through communication connections between multiple television devices, a user is able to push the AV content presently obtained by a tuner of a local television device to other television devices or to obtain the AV content of other channels from the tuner of another television device and simultaneously display the AV content obtained by the tuner of the local television device and the pulled in AV content at a same television device. In this way, the invention can flexibly and effectively share television programs between the television devices.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a television programs sharing system.

FIG. 2 is a functional block diagram of a television device according to an exemplary embodiment of the invention.

FIG. 3 is a flowchart of a method for sharing television programs according to a first exemplary embodiment of the invention.

FIG. 4 is a flowchart of a method for sharing television programs according to a second exemplary embodiment of the invention.

FIG. 5 is a flowchart of a method for sharing television programs according to a third exemplary embodiment of the invention.

FIG. 6 is a flowchart of a method for sharing television programs according to a fourth exemplary embodiment of the invention.

### DETAILED DESCRIPTION OF THE EMBODIMENTS

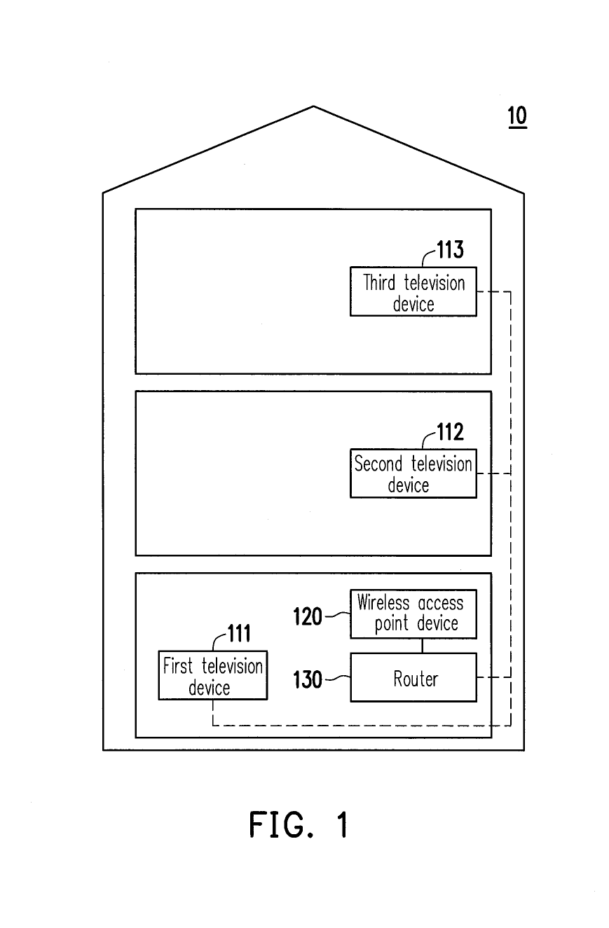

The invention provides a method for sharing television programs, which is suitable for sharing television program content between multiple television devices by using wired communication technology or wireless communication technology. The method for sharing television programs is suitable for a television programs sharing system as illustrated in FIG. 1, in which the television programs are shared between two or more than two television devices.

FIG. 1 is a schematic diagram of a television programs sharing system. Referring to FIG. 1, the television programs sharing system 10 includes a first television device 111, a second television device 112, a third television device 113, a wireless access point device 120 and a router 130. The wireless access point device 120 is, for example, a receiver supporting wireless LAN function, in which the wireless LAN functionality, is for example, a wireless communication function in conformance with to Wi-Fi (wireless fidelity) standard or IEEE 802.11 standard.

The first television device 111, the second television device 112 and the third television device 113 can be placed at different floors or in different rooms. For example, the first television device 111, the second television device 112 and the third television device 113 can be respectively placed at the first floor, the second floor and the third floor of a building. In another example, the first television device 111, the second television device 112 and the third television device 113 can be respectively placed in three different rooms of a same floor, which the invention is not limited to and other space combinations/configurations for placing the television devices are allowed. In other embodiments, the television programs sharing system can have two television devices only or have over three television devices. FIG. 1 is an illustrative example only, not to limit the implementations of the method for sharing television programs of the invention.

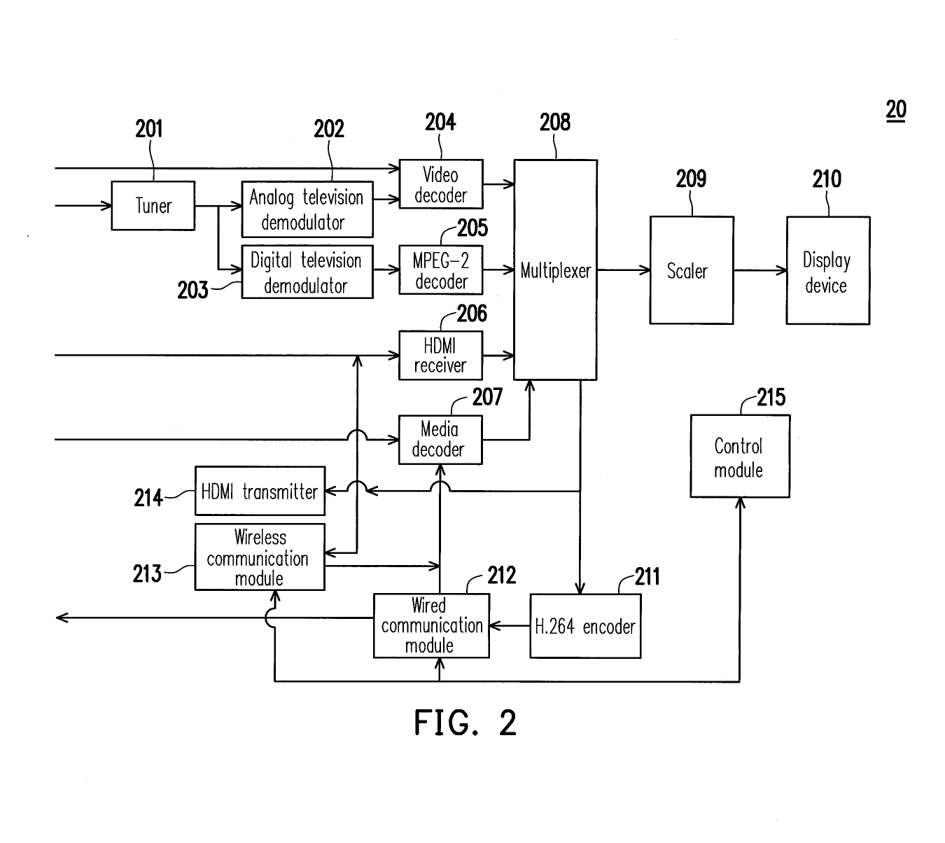

In the embodiment, the first television device 111, the second television device 112 and the third television device 113 can be connected to each other by using the router 130 so as to form a wired LAN. However, the implementations of the invention are not limited to the wired LAN. In fact, the first television device 111, the second television device 112 and the third television device 113 can be connected to each other by using the wireless access point device 120, in which the wireless access point device 120 can be further connected to the router 130 and moreover to Internet (not shown). FIG. 2 is a functional block diagram of a television device according to an exemplary embodiment of the invention, in which the details of a television device able to share television programs with other television devices is explained below.

Referring to FIG. 2, a television device 20 includes a tuner 201, an analog television demodulator 202, a digital television demodulator 203, a video decoder 204, an MPEG-2 decoder 205, a high definition multimedia interface (HDMI) receiver 206, a media decoder 207, a multiplexer 208, a scaler 209, a display device 210, an H.264 encoder 211, a wired communication module 212, a wireless communication module 213, an HDMI transmitter 214 and a control module 215.

The tuner 201 is configured for selecting a frequency-channel of radio-frequency (RF) signal and respectively providing a terrestrial/satellite analog broadcasting signal or a terrestrial/satellite digital broadcasting signal to the analog television demodulator 202 and the digital television demodulator 203.

The analog television demodulator 202 is connected to the tuner 201, and configured for receiving an analog television broadcast signal and demodulate the analog television broadcast signal so as to provide a television program signal to the video decoder 204.

The digital television demodulator 203 is connected to the tuner 201, and configured for receiving a digital television broadcast signal and demodulating the digital television broadcast signal so as to provide a television program signal to the MPEG-2 decoder 205.

The video decoder 204 is connected to the analog television demodulator 202, and configured for decoding the television program signal and providing the decoded video content and audio content to the multiplexer 208. The video decoder 204 can also alternatively be connected to an external set-top-box (STB) (not shown), and configured for decoding the television program signal provided by the external STB.

The MPEG-2 decoder 205 is connected to the digital television demodulator 203, and configured for decoding the television program signal and providing the decoded video content and audio content to the multiplexer 208. In other embodiments, the MPEG-2 decoder 205 can be replaced by another decoder corresponding to the video coding standard supported by the digital television demodulator 203.

The HDMI receiver 206 is connected to an external transmission line (not shown) or the wireless communication module 213, and configured for receiving an HD multimedia content provided by an external HD multimedia signal source (not shown) and then providing the HD multimedia content to the multiplexer 208.

The media decoder 207 is connected to an external multimedia signal source (not shown) and a wired communication module, and configured for receiving a multimedia signal, decoding the multimedia signal and providing the decoded video content and audio content to the multiplexer 208.

The multiplexer 208 is connected to the video decoder 204, the MPEG-2 decoder 205, the HDMI receiver 206 and the media decoder 207, and the multiplexer 208 is configured for multiplexing the multimedia contents of the input terminals and outputting multiplexed video content and audio content to the scaler 209. In addition, the multiplexer 208 is also connected to the H.264 encoder 211, and configured for outputting the multiplexed video content and audio content or one of the multimedia content of the input terminals to the H.264 encoder 211 for performing compression coding processing. The multiplexer 208 is further connected to the wireless communication module 213 or the HDMI transmitter 214, and configured for outputting the multiplexed video content and audio content or one of the multimedia content of the input terminals to the wireless communication module 213 or the HDMI transmitter 214, followed by transmitting the multimedia content to an external display device.

The scaler 209 is connected to the multiplexer 208, and configured for advancing the image quality of the video content and adjusting the displaying scale of the video content according to the resolution of the following-stage display device 210. The display device 210 is connected to the scaler 209 and outputs the video content and audio content. The scaler 209 is also configured to generate at least one main picture and a sub-picture or two separated pictures, i.e., a picture-on-picture (POP) simultaneously displayed at the frame of the display device 210.

The H.264 encoder 211 is connected to the wired communication module 212, and configured for outputting coded signal to the wired communication module 212 and transmitting the coded signal to an external display device. The wired communication module 212 supports a wired LAN communication technique, for example, Ethernet or IEEE 802.3 standard; while the wireless communication module 213 supports, for example, a Wi-Fi standard, a wireless home digital interface (WHDI) standard, a wireless HD transmission technique or a WiFi Direct transmission technique.

In addition, the wired communication module 212 also supports digital living network alliance (DLNA) standard and can obtain a multimedia signal from the wired LAN and transmits the multimedia signal to the media decoder 207 to perform decoding processing. Similarly, the wireless communication module 213 can obtain a multimedia signal from the wireless LAN, and then transmit the multimedia signal to the media decoder 207 to perform decoding processing.

The control module 215 is connected to the wired communication module 212 and the wireless communication module 213, and is configured for receiving/transmitting messages and commands and controlling the aforementioned components according to the received messages or commands (limited by the diagram space, not all the connections are shown in FIG. 1).

The first television device 111, the second television device 112 and the third television device 113 of the television programs sharing system 10 can respectively have all or most components of the television device 20 and the corresponding functions. For example, the first television device 111 can include merely the analog television demodulator 202, the video decoder 204 and other components related to performing decoding processing and communication, but does not include the digital television demodulator 203 and the MPEG-2 decoder 205. The second television device 112 can include merely the digital television demodulator 203, the MPEG-2 decoder 205 and other components related to performing decoding processing and communication, but does not include the analog television demodulator 202 and the video decoder 204. The third television device 113 can include merely the wireless communication module 213 and other components related to performing decoding processing on the video content and audio content, but does not include the wired communication module 212 and the media decoder 207.

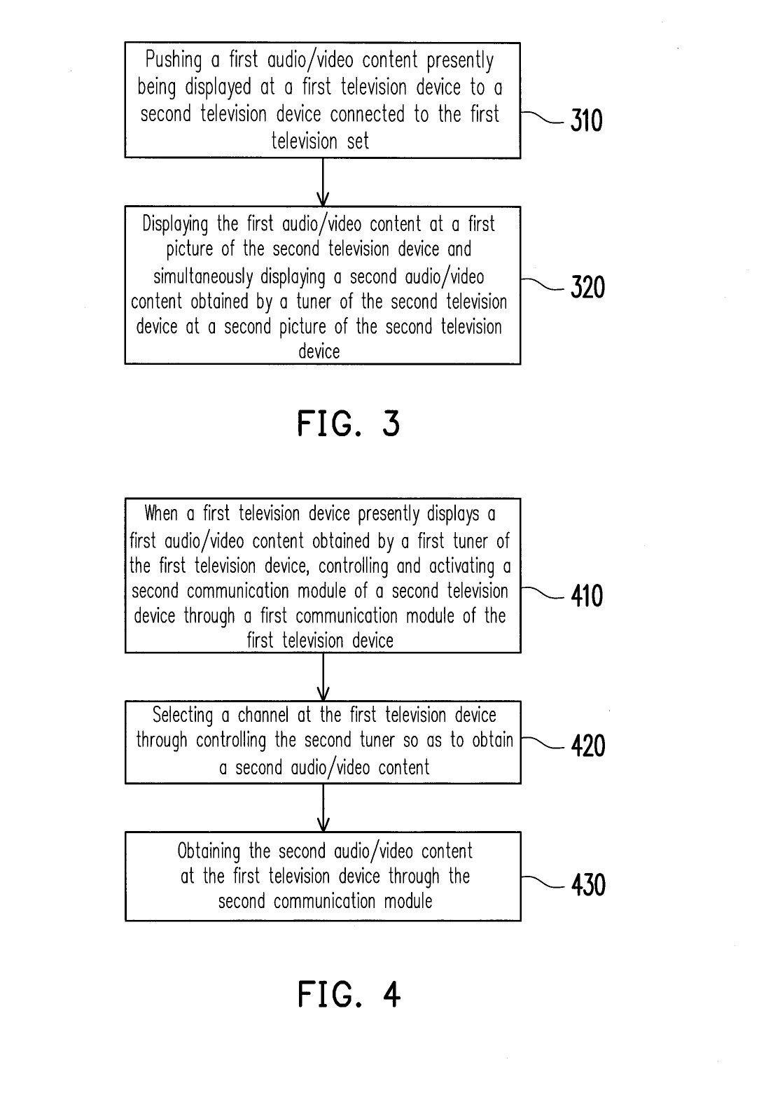

FIG. 3 is a flowchart of a method for sharing television programs according to the first exemplary embodiment of the invention. Referring to FIGS. 1, 2 and 3, the workflow of the method for sharing television programs begins from step 310. In the step 310, the first television device 111 pushes the first AV content presently being displayed at the first television device 111 to the second television device 112 connected to the first television device 111. In step 320, the first picture of the second television device 112 is displaying the first AV content and the second AV content obtained by a tuner of the second television device is simultaneously displayed at the second picture of the second television device 112.

The first picture and the second picture of the second television device 112 can form a picture-in-picture (PIP), in which the first picture can be a sub-picture, the second picture can be a main picture, the sub-picture is stacked on the main picture and the first picture is smaller than the second picture.

The invention is not limited to the implementation to the aforementioned configuration. The first picture and the second picture of the second television device 112 can also form a picture-on-picture (POP), and the first picture and the second picture are simultaneously displayed in a display screen of the second television device, but the first picture and the second picture of the second television device 112 are not overlapped with each other. Further, the user can switch the displaying contents between the first picture and the second picture through controlling, so that the first picture of the second television device 112 displays the second AV content, while the second picture displays the first AV content obtained from the first television device. In other embodiments, the second television device 112 is able to display the first AV content obtained from the first television device, but does not display the second AV content obtained by the tuner of the second television device 112. Alternatively, the second television device 112 is able to display the second AV content obtained by the tuner thereof, but does not display the first AV content obtained from the first television device. The user can also switch the displaying contents between the first AV content and the second AV content through controlling.

In the method for sharing television programs of FIG. 3, before the first AV content is pushed to the third television device 113 from the first television device 111, the method for sharing television programs further includes: transmitting a notification message from the first control module of the first television device 111 to the second control module of the second television device 112, in which the notification message includes program name corresponding to the first AV content; when an acknowledgement (ACK) message responded by the second control module of the second television device 112 is received by the first control module of the first television device 111 the first television device 111 pushes the first AV content to the second television device 112, in which the ACK message represents that the user of the second television device 112 agrees with receiving the first AV content to watch. The notification message can be an request message as well.

Further, the first television device 111 can be connected to the second television device 112 through one of a wired LAN and a wireless LAN and push the first AV content to the second television device 112 through one of a wireless LAN, a wired LAN, a DLNA standard, a WHDI technique, a wireless HD transmission technique and a WiFi Direct transmission technique.

FIG. 4 is a flowchart of a method for sharing television programs according to a second exemplary embodiment of the invention. Referring to FIGS. 1, 2 and 4, the workflow of the method for sharing television programs begins from step 410. In the step 410, when the first television device 111 is presently displaying the first AV content obtained by the first tuner of the first television device 111, the first television device 111 controls the second communication module of the second television device 112 (the second communication module is, for example, the wired communication module or the wireless communication module of the first television device 111) through the first communication module thereof (the first communication the module corresponding to the wired communication module or the wireless communication module of the first television device 111).

In step 420, the first television device 111 selects a channel by controlling the second tuner of the second television device 112 so as to obtain the second AV content. In step 430, the first television device obtains the second AV content through the second communication module of the second television device 112.

The method for sharing television programs of FIG. 4 further includes: simultaneously displaying the second AV content at the second picture of the first television device 111 when the first AV content is displayed at the first picture of the first television device 111. Similar to the embodiment of FIG. 3, in the present embodiment, the user can switch the displaying contents between the first picture and the second picture of the first television device 111, and the first picture and the second picture can form a PIP or a POP.

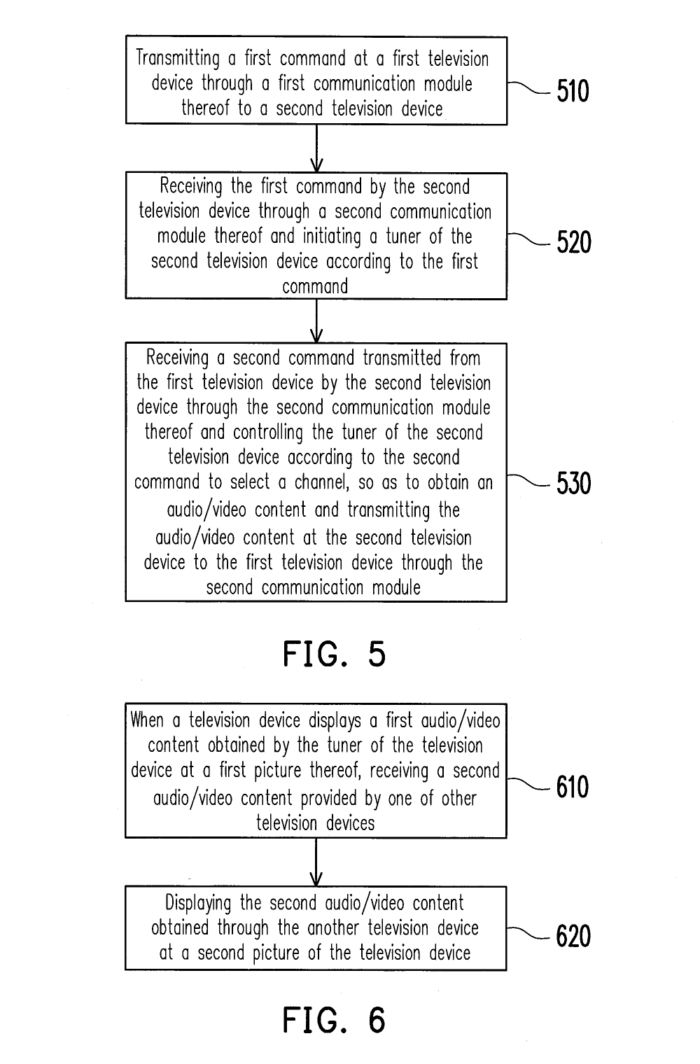

FIG. 5 is a flowchart of a method for sharing television programs according to a third exemplary embodiment of the invention. Referring to FIGS. 1, 2 and 5, the workflow of the method for sharing television programs begins from step S510. In the step S510, the first television device 111 transmits a first command to the second communication module of the second television device 112 (the second communication module is corresponding to the wired communication module or the wireless communication module of the first television device 111) through the first communication module of the first television device 111 (the first communication module is, for example, the wired communication module or the wireless communication module of the first television device 111). At the time, the displaying unit of the second television device 112 is in deactivated state.

In step 520, the second television device receives the first command through the second communication module thereof and activates the tuner of the second television device 112 according to the first command. In step 530, the second television device 112 receives a second command transmitted by the first television device through the second communication module thereof and controls the tuner of the second television device 112 according to the second command, so as to select a channel for obtaining an AV content, and further transmits the obtained AV content to the first television device 111 through the second communication module of the second television device 112. The first television device 111 receives the AV content through the first communication module thereof.

It should be noted that the method for sharing television programs of FIG. 5 can be applied in the situation where the displaying unit (or display device) of the second television device 112 is in a deactivated state. To more clearly explain the manner of receiving/transmitting commands and transmitting the AV content between the first television device 111 and the second television device 112, an example is described below. When the displaying unit (or a display device) of the second television device 112 is in a deactivated state, the second communication module thereof (for example, a Wi-Fi module) would enter a sleep mode, but the second communication module would wake up in a preset time. When the first television device 111 sends the first command or the second command to the second television device 112, if at the time the second television device 112 is still in the sleep mode (corresponding to the television device 112 not waking up yet), the first television device 111 can continuously transmit the same command until the second television device 112 wakes up to pick up the command transmitted by the first television device 111. At the time, the second television device 112 responds with an ACK message. Meanwhile, the control module of the second television device 112 activates the tuner of the second television device 112 so as to adjust the tuner of the second television device 112 to the channel specified by the first television device 111 and to receive the television program content, followed by transmitting the content to the first television device 111. After the television program content is transmitted, the second television device 112 enters the sleep mode again and keeps in the sleep mode until waking up again in the present time, or the aforementioned workflow is repeated.

FIG. 6 is a flowchart of a method for sharing television programs according to a fourth exemplary embodiment of the invention. Referring to FIGS. 1, 2 and 6, the workflow of the method for sharing television programs begins from step 610. In step 610, when the first television device 111 is displaying the first AV content obtained by the tuner of the first television device 111 at the first picture of the first television device 111, the first television device 111 receives the second AV content provided by another television device (for example, the second television device 112 or the third television device 113). In step 620, the first television device 111 is displaying the second AV content obtained by the other television device at the second picture of the first television device 111. In addition, similar to the embodiment of FIG. 3, in the present embodiment, the user can switch the displaying contents between the first picture and the second picture of the first television device 111, in which the first picture and the second picture can form a PIP or a POP.

In summary, according to the aforementioned embodiments, the invention provides methods for sharing television programs. Through wired communication connections or a wireless communication connection between multiple television devices, a user is able to push the AV content obtained by a tuner of a local television device to other television devices or to obtain the AV content of other channels from the tuner of another television device and simultaneously display the AV content obtained by the tuner of the local television device and the pulled in AV content at a same television device. In this way, the invention can flexibly and effectively share television programs between the television devices.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A method for sharing television programs, comprising:
pushing a first audio/video content presently being displayed at a first television device to a second television device connected to the first television device; and
displaying the first audio/video content at a first picture of the second television device and simultaneously displaying a second audio/video content obtained by a tuner of the second television device at a second picture of the second television device.

2. The method as claimed in claim 1, wherein the first picture and the second picture form a picture-in-picture (PIP), wherein the first picture is a sub-picture and the second picture is a main picture.

3. The method as claimed in claim 1, wherein the first picture is smaller than the second picture.

4. The method as claimed in claim 1, wherein prior to pushing the first audio/video content to the second television device, the method further comprises:
transmitting a notification message from the first television device to the second television device, wherein the notification message comprises a program name corresponding to the first audio/video content; and
when the first television device receives an acknowledgment message responded by the second television device, pushing the first audio/video content to the second television device.

5. The method as claimed in claim 1, wherein the first television device is connected to the second television device through one of a wired LAN and a wireless LAN, and the method comprises:
pushing the first audio/video content to the second television device through one of the wireless LAN, the wired LAN, a DLNA standard, a WHDI standard, a wireless HD transmission technique and a WiFi Direct transmission technique.

6. A method for sharing television programs, comprising:
when a first television device presently displays a first audio/video content obtained by a first tuner of the first television device, controlling, through a first communication module of the first television device, a second communication module of a second television device so as to activate a second tuner of the second television device, wherein a display unit of the second television device is in a deactivated state;
selecting a channel by the first television device through controlling the second tuner so as to obtain a second audio/video content; and
obtaining the second audio/video content by the first television device through the second communication module.

7. The method as claimed in claim 6, further comprising:
displaying the first audio/video content at a first picture of the first television device and simultaneously displaying the second audio/video content at a second picture of the first television device.

8. The method as claimed in claim 7, wherein the first picture and the second picture form a picture-in-picture (PIP), wherein the second picture is a sub-picture and the first picture is a main picture.

9. The method as claimed in claim 6, wherein the first television device is connected to the second television device through one of a wired LAN and a wireless LAN.

10. A method for sharing television programs, comprising:
transmitting a first command by a first television device through a first communication module thereof to a second television device;
receiving the first command by the second television device through a second communication module thereof and activating a tuner of the second television device according to the first command; and
receiving a second command transmitted from the first television device by the second television device through the second communication module thereof, and controlling the tuner of the second television device according to the second command to select a channel so as to obtain an audio/video content and transmitting the audio/video content to the first television device by the second television device through the second communication module.

11. The method as claimed in claim 10, wherein a display unit of the second television device is in a turning-off state.

12. The method as claimed in claim 10, wherein the first television device is connected to the second television device through one of a wired LAN and a wireless LAN.

13. A method for sharing television programs, suitable for a television device with one tuner only, and comprising:
when the television device displays a first audio/video content obtained by the tuner of the television device at a first picture thereof, receiving a second audio/video content provided by one of other television devices; and
displaying the second audio/video content obtained through the another television device at a second picture of the television device.

14. The method as claimed in claim 13, wherein the first picture and the second picture comprise a picture-in-picture (PIP), wherein the second picture is a sub-picture and the first picture is a main picture.

15. The method as claimed in claim 13, wherein the television device obtains the second audio/video content through one of a wired LAN and a wireless LAN from the another television device and obtains the second audio/video content from the another television device through a DLNA standard, a WHDI standard, a wireless HD transmission technique or a WiFi Direct transmission technique.
